(19) United States
(12) Patent Application Publication
(10) Pub. No.: US 2026/0018798 A1
(43) Pub. Date: Jan. 15, 2026

(54) LOW-PROFILE ANTENNA WITH TWO-DIMENSIONAL ELECTRONIC SCANNING

(71) Applicant: COMMISSARIAT A L'ENERGIE ATOMIQUE ET AUX ENERGIES ALTERNATIVES, Paris (FR)

(72) Inventors: Francesco FOGLIA MANZILLO, Grenoble Cedex 09 (FR); Maciej SMIERZCHALSKI, Saint-Egreve (FR)

(73) Assignee: COMMISSARIAT A L'ENERGIE ATOMIQUE ET AUX ENERGIES ALTERNATIVES, Paris (FR)

(21) Appl. No.: 18/864,168

(22) PCT Filed: May 11, 2023
(86) PCT No.: PCT/EP2023/062689

§ 371 Date: Sep. 30, 2025

(30) Foreign Application Priority Data
May 11, 2022 (FR) 2204480

(51) Int. Cl. H01Q 13/28; H01P 1/185; H01Q 3/26; H01Q 21/00

(52) U.S. Cl. CPC H01Q 13/28; H01P 1/185; H01Q 3/26; H01Q 21/0031

(57) ABSTRACT

A two-dimensional beam scanning antenna includes a folded parallel-plate waveguide that emits a quasi-planar wave in a first direction; a linear array of stubs extending in a second direction perpendicular to the first; a first and a second phase-shifting surface which have elementary phase-shifting cells and elementary phase-shifting bands, respectively. Each band is associated with a stub; and a first and a second set of control lines, controlling the phase shifts of the elementary phase-shifting cells and bands, respectively, so as to control the orientation of the beam in a plane orthogonal to the first and the second direction, respectively. The first phase-shifting surface is a reflective phase-shifting surface, which receives the planar wave propagating in the first direction and reflects it in the opposite direction after phase-shifting.

### TECHNICAL FIELD

The present invention generally relates to the field of phased-array antennas enabling two-dimensional control of steering of the beam. It finds particular application in terrestrial terminals in the K/Ka band for satellite communications, communication systems on-board trains or aircrafts, 5G base stations, near-field microwave focusing systems.

### PRIOR ART

Two-dimensional scanning antennas are well-known in the prior art, in particular for satellite communication terminals or communication systems on-board moving vehicles. These allow controlling in a dynamic manner the direction of the beam (in emission and/or reception) according to two orthogonal axes and are consequently capable of scanning a predetermined solid angle.

The first generation of two-dimensional scanning antennas uses a mechanical scanning. These generally include a directional antenna (for example parabolic) mounted on a universal joint allowing steering it according to two axes. Apart from the fact that they do not allow fast angular scanning, these antennas are bulky and heavy. They are difficult to integrate into vehicles and very often degrade their aerodynamic behaviour. Finally, the servomotors that equip them require substantial maintenance and are energy-intensive.

To overcome these drawbacks, a second generation of antennas uses phased-array antennas (phased array) and beamforming techniques allowing electron scanning. These second-generation antennas are not very bulky and could conform to the shape of a vehicle (conformal antennas on an aircraft, for example). They enable fast angular scanning, in the absence of any mechanical inertia. On the other hand, the large number of elementary antennas forming the array makes them particularly complex and expensive to manufacture.

Hybrid mechanical/electronic scanning antennas are also available on the market, using for example a mechanical positioner in azimuth and an electronic scanning in elevation. Nonetheless, their performance is not optimum, mechanical aiming remains slow and their bulk is too large for a large number of applications.

Recently, an antenna adapted for one-dimensional electronic scanning using an array of transverse continuous stubs or CTS (Continuous Transverse stubs) array has been described in the article by M. Ettore et al. entitled “Continuous transverse stub array for Ka-band applications” published in IEEE Trans. Antennas Propag., vol. 63, No. 11, pp. 4792-480 November 2015.

Such an antenna has been schematically shown in FIG. 1A. The latter comprises an array of continuous stubs, the considered stubs extending in a direction (Oy) transverse to a waveguide to a parallel-plate waveguide or PPW guide (Parallel-plate waveguide), 140. As illustrated in FIG. 1B, the supply of the CTS array from the waveguide is obtained by means of an arborescence of T-junctions whose different branches supply the stubs.

For simplicity, the stubs have been shown herein with a zero height and are therefore reduced to transverse radiative slots 111, parallel to the axis (Oy).

By “stub”, in a manner known per se, it is herein referred to a portion, a guide section open in the direction orthogonal to the direction of propagation of the wave, allowing performing impedance transformations.

FIGS. 1C and 1D respectively show a section of the PPW waveguide according to a plane (xy) and a plane (xz).

A microwave source in the Ka band, 130, herein a sectorial plane H (H-plane sectorial horn) injects a wave into the PPW waveguide, 140. The sectorial horn is flared in the plane H of the PPW waveguide in other words in the plane (xy). The PPW waveguide has a transition section of the “pillbox” or “U”-shaped type, 160, so that it is folded back on itself, said transition section ensuring connection between a first rectilinear section 141 and a second rectilinear section 142, substantially parallel to one another. The sectorial horn 130 opens directly into the first rectilinear section of the PPW waveguide and the second rectilinear section of the PPW waveguide opens onto the parallel supply array 120 of the CTS network.

The transition section has a parabolic reflector 150 in the plane (xy) as shown in FIG. 1C. The focal point of the parabolic reflector is located at the centre of the aperture of the sectorial horn, which allows obtaining a quasi-planar wave in the second section of the PPW waveguide.

A change in the position of the sectorial horn along the axis (y), at the input of the PPW waveguide, modifies the phase distribution according to this axis and ensures a scanning of the beam in the plane H at the output of the CTS array, in other words scanning in the plane (yz). Thus, by mechanically moving the horn antenna in front of the input of the waveguide or by switching the power supply of several sector horns arranged according to the axis (y) in front of this same input, it is possible to obtain a one-dimensional scanning of the beam in the plane (yz). Nonetheless, in most embodiments, this architecture only allows switching between a discrete set of beams and does not offer any fine angular de-aiming of the antenna beam in the scanning plane (yz).

A two-dimensional electronic scanning antenna using a CTS network has been disclosed in the patent U.S. Pat. No. 6,677,899. the CTS network supplies in near-field an array of radiating elements reconfigurable by MEMS located above the latter. Each element comprises at the input a wide-band receiver element, at the output a wide-band receiver element and a phase-shifting module controlled by MEMS between the input element and the output element.

Nonetheless, such an antenna is very complex to make and is subject to malfunctions of the MEMS devices, generally not very reliable over time. Furthermore, the alignment between the array of lenses and the feed network CTS should be accurate, failing what the insertion losses might be considerable. The two arrays cannot be integrated in the same monolithic structure to the extent that the reconfigurable array is made in the form of a plurality of printed circuits or PCBs (printed circuit board) mounted vertically in parallel above the feed network CTS. Finally, scanning of the beam assumes the ability to individually control each MEMS device and therefore to have a control network including as many lines as MEMS devices.

Transmitter array antennas (transmitarray antennas) offer a compact solution when it is desired to carry out a two-dimensional electron scanning (scanning with 2 degrees of freedom, in a half-space). An embodiment of such a transmitter array could be found in the article by 5 entitled “Reconfigurable A. R. Vilenskiy et al. transmitarray with near-field coupling to gap waveguide array antenna for efficient 2-D beam steering” published in IEEE Trans. Antennas Propag. Vol. 68, No. 12, pp 7854-7865. More specifically, the two-dimensional scanning antenna herein comprises a first 2D array of slot antennas illuminating in near-field a transmitter array in the form of a phase-shifting surface or PSS (Phase-shifting Surface). The phase-shifting surface is formed by a two-dimensional array of elementary cells, each elementary cell comprising a first elementary antenna in reception and being connected to a second elementary antenna in transmission via a phase-shifting module. Each phase-shifting module is individually controllable so as to be able to control the steering and perform a two-dimensional scanning of the beam. Nonetheless, such an antenna requires a complex control network, the number of layers, of power dividers increasing according to the size of the antenna. Furthermore, the near-field coupling between the array of slot antennas and the transmitter array necessarily induces insertion losses which are even higher as the size of the array is large.

Consequently, an object of the present invention is to provide a two-dimensional electronic scanning antenna (with 2 degrees of freedom) which does not have the aforementioned drawbacks, in particular which is simple, energy-efficient and small-sized, easily integrable and does not require a large number of control lines, even for large-sized antennas.

### DISCLOSURE OF THE INVENTION

The present invention is defined by a two-dimensional beam scanning antenna comprising a waveguide intended to be powered by a microwave source and to supply a quasi-planar wave propagating in a first direction, a linear array of transverse stubs, extended according to a second direction perpendicular to the first one, said stubs being arranged periodically according to the first direction with a pitch substantially equal to the wavelength guided in the waveguide, said antenna being original in that it comprises:
a first electronically reconfigurable phase-shifting surface comprising a first plurality, M, of elementary phase-shifting cells arranged periodically according to the second direction with a pitch smaller than or equal to the free space half-wavelength of the microwave source;
a second electronically reconfigurable phase-shifting surface comprising a second plurality, N, of elementary phase-shifting bands, each elementary phase-shifting band being extended according to the second direction and being associated with a transverse stub of said array, said elementary phase-shifting band being arranged directly on the output of the transverse stub to which it is associated;
a first set of control lines for controlling the respective phase-shifts of the elementary phase-shifting cells so as to control the orientation of the beam in a plane orthogonal to the first direction;
a second set of control lines for controlling the respective phase-shifts of the elementary phase-shifting bands so as to control the orientation of the beam in a plane orthogonal to the second direction; and in that the first phase-shifting surface is a reflective phase-shifting surface adapted to receive the wave supplied by the microwave source propagating in a direction opposite to the first direction and to reflect it in the first direction after the elementary phase-shifting cells have applied thereto first phase-shift values along the second direction.

Preferably, each of the elementary cells of the first phase-shifting surface is a reflective cell, configured to receive the planar wave propagating in the first direction and reflect it in the opposite direction.

In some embodiments, each elementary cell of the first surface and/or each elementary band of the second surface is controlled using one single control line.

In this case, it is considered that each of the M cells of the first surface and each cell of the N phase-shifting bands of the second surface can introduce, respectively, K₁ and K₂ different phase-shift values; the total number of diode control lines of the diodes is Mlog2K₁+Nlog₂K₂. Hence, the number of control lines increases less rapidly with the radiating surface compared to an equivalent 2-D scanning antenna of the transmitter or phased array type with NM radiating elements, which would require NMlog₂K₁ log₂K₂ control lines or NM RF channels, respectively.

In some embodiments, at least one of the controllable systems comprises (is based on) PIN diodes.

An embodiment of a phase-shifting cell, electronically reconfigurable using PIN diodes, in transmission, adapted to the second phase-shifting surface, is described in the patent U.S. Pat. No. 10,680,329 B2 by A. Clemente, L. Dussopt, L. Di Palma, entitled “Unit cell of a transmission network for a reconfigurable antenna”.

Preferably, the waveguide is a parallel-plate waveguide.

Advantageously, it comprises a first rectilinear section in which the wave emitted by the microwave source propagates in a direction opposite to the first direction, a second rectilinear section, parallel to the first rectilinear section, in which the planar wave propagates in the first direction after having been phase-shifted by the first phase-shifting surface and a U-shaped transition section, ensuring the 180° folding and connecting the first rectilinear section to the second rectilinear section.

According to some variants, the first phase-shifting surface is arranged on a cylindrical-parabolic structure.

According to a variant, the waveguide is supplied by the microwave source through a sectorial horn.

Thus, the waveguide may comprise, in its transition section, a cylindrical-parabolic structure enabling the first phase-shifting surface to reflect the wave supplied by the microwave source through the sectorial horn in the form of a quasi-planar wave.

Advantageously, each elementary phase-shifting band may consist of a plurality P of second elementary cells, said second elementary cells of an elementary phase-shifting band being arranged periodically according to the second direction with a pitch smaller than or equal to the free space half-wavelength, the same phase-shift value being applied to said plurality of second elementary cells belonging to the same elementary phase-shifting band.

Each first elementary cell, respectively each second elementary cell, may comprise a plurality of metal layers alternating with dielectric layers as well as a plurality of PIN diodes interconnecting at least some of said different metal layers, controlled by a plurality k of control lines of the first, respectively second, set.

Each first elementary cell, respectively each second elementary cell, may comprise a plurality of varactor diodes, controlled by at least one control line of the first, respectively second, set.

In some embodiments, each elementary cell of the second phase-shifting surface (in transmission, on the stubs) is configured so as to radiate a field having a fixed circular polarisation (i.e. either right circular or left circular).

This reconfigurable cell receives and therefore transforms the linear polarisation field emitted by each stub, into a fixed circular polarisation field and, at the same time, introduced on this field an electronically-variable phase-shift between a set of K2 different values. An embodiment of such a cell reconfigurable in transmission using PIN diodes is described for example in the document by L. Di Palma, A. Clemente, L. Dussopt, R. Sauleau, P. Potier, and Ph. Pouliguen, “Experimental Characterization of a Circularly Polarised 1 Bit Unit Cell for Beam Steerable Transmitarrays at Ka-Band”. IEEE Trans. Antennas Propag., vol. 67, No. 2, February 2019.

In some embodiments, each elementary cell of the second phase-shifting surface (in transmission, on the stubs) is configured to radiate a field having a circular polarisation with an electronically reconfigurable direction (right or left).

Such a cell may be made using PIN diodes according to the design described in the document by F. Foglia Manzillo et al., Transmitarray antenna cell (patent US 2022/0359982 A1).

In another embodiment, this reconfigurable cell (elementary cell of the second phase-shifting surface) may be composed of a first section which receives the linear polarisation field emitted by each stub and transmits it while introducing on this field an electronically-variable phase-shift between a set of K2 different values, and a second section which operates as an electronically-reconfigurable polarisation converter (linear-to-circular). This second section receives the linear polarisation field transmitted by the first section and emits a polarisation field in linear polarisation with an electronically-reconfigurable direction (right/left). One possible implementation of such a cell using PIN diodes provides for stacking: (i) (first section), the cell in transmission with reconfigurable phase-shifting described in the patent of A. Clemente, L. Dussopt, L. Di Palma, entitled “Unit cell of a transmission network for a reconfigurable antenna” (U.S. Pat. No. 10,680,329 B2); (ii) (second section), the cell of the reconfigurable polarisation converter described in the patent of A. Clemente entitled “Transmitarray antenna cell” (US 2023 0010547 A1).

In some embodiments, the two-dimensional beam scanning antenna is configured to emit two beams, with orthogonal polarisations and independently controllable, and such that each band of the second phase-shifting surface (in transmission, on the stubs) comprises two sets of reconfigurable phase-shifting cells capable of radiating fields having orthogonal polarisations. For example, the cells of the first set may be configured to radiate a horizontal linear polarisation field and those of the second set to radiate a vertical linear polarisation field, respectively. Thus, two beams with orthogonal polarisations could be formed. The de-aiming directions of these two beams could be reconfigured independently by controlling with two sets of control lines the two sets of cells of each band.

An embodiment of the cells of the two sets, using PIN diodes, able to receive a vertical linear polarisation and to radiate either a horizontal linear polarisation field, or a vertical linear polarisation field is described in the document by F. Foglia Manzillo et al. “A Ka-band Beam-Steering Transmitarray Achieving Dual-Circular Polarisation”, 15th Eur. Conf. Antennas Propag. (EuCAP), Dusseldorf, Germany, 2021.

### BRIEF DESCRIPTION OF THE DRAWINGS

Other features and advantages of the invention will appear upon reading a preferred embodiment of the invention, made with reference to the appended figures wherein:

FIGS. 1A to 1D, already described, show different views of a one-dimensional electronic scanning antenna known from the prior art;

FIG. 2 schematically shows a two-dimensional electron scanning antenna according to an embodiment disclosed to help understand the invention;

FIG. 3 schematically shows the control lines of the first and second phase-shifting surfaces used in the antenna of FIG. 2;

FIG. 4 schematically shows a two-dimensional electron scanning antenna according to an embodiment of the invention;

FIG. 5 illustrates a PPW waveguide comprising a slow-wave structure, used in a variant of the first or second embodiment of the invention; and

FIGS. 6A and 6B schematically show, respectively in perspective and in section, a reflective cell that could be used in an antenna according to the present invention.

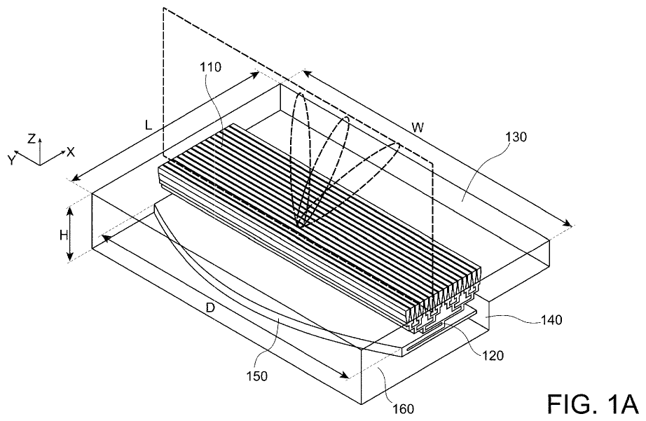

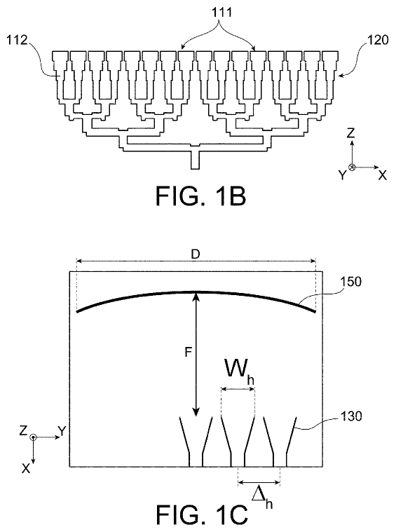

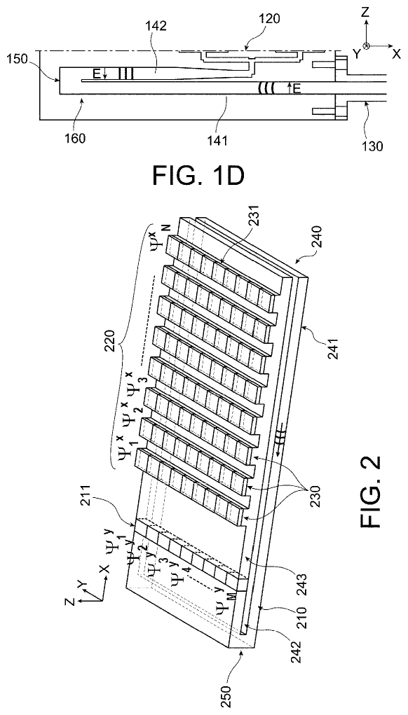

### DETAILED DISCLOSURE OF PARTICULAR EMBODIMENTS

Next, we will consider a two-dimensional electronic scanning antenna, i.e. an antenna whose beam could be steered according to 2 degrees of freedom. For example, the beam could be steered about two orthogonal axes, in azimuth and in elevation.

The antenna according to the present invention is intended to operate with a microwave source typically operating in the millimetre and centimetre bands, from 3 to 300 GHz. It is particularly adapted to operate in the frequency range from 10 GHz to 60 GHz and may in particular be used in satellite terminals (in the K/Ka bands) or 5G terminals/base stations.

The considered antenna uses a waveguide acting as a quasi-optical beamformer. This waveguide supplies a planar or quasi-planar wave, preferably in the quasi-TEM (Transverse Electro-Magnetic) mode propagating in a first direction (Ox), to an array of radiating transverse stubs, or slots, extended in a second direction (Oy), perpendicular to the first direction.

The idea at the origin of the present invention is to provide a first phase-shifting surface comprising a first plurality, M, of elementary phase-shifting cells arranged periodically according to the second direction and a second phase-shifting surface, comprising a second plurality, N, of elementary phase-shifting bands, each elementary phase-shifting band being extended according to the second direction and being associated with a continuous transverse stub, or slot, of the array and arranged directly above the latter.

The first phase-shifting surface ensures scanning of the beam in the plane (xy). The second phase-shifting surface ensures scanning of the beam around the second direction in the plane (xz). For example, the first phase-shifting surface could ensure scanning of the beam in azimuth and the second phase-shifting surface could ensure scanning of the beam in elevation.

Advantageously, the waveguide is made in the form of a parallel-plate waveguide or PPW (Parallel-plate waveguide), folded on itself for compactness. It comprises a first rectilinear section in a direction opposite to the first direction, a second rectilinear section, parallel to the first rectilinear section, and a U-shaped transition section, ensuring 180° folding while connecting the first rectilinear section to the second rectilinear section. The transition section may comprise a reflector allowing reversing the direction of propagation between the first rectilinear section and the second rectilinear section of the waveguide.

The waveguide, and more specifically its first rectilinear section, is supplied by a primary source, for example by means of a horn antenna, more specifically a sectorial horn, the wide edges of the sectorial horn joining the top and bottom plates of the guide and the narrow edges joining the lateral walls of the guide, so as to minimise insertion losses.

FIG. 2 schematically shows a two-dimensional electron scanning antenna in a first embodiment which does not correspond to the present invention but is useful for understanding the latter.

Unless indicated otherwise, the technical features of this embodiment that are technically compatible with the present invention may be applied thereto.

The waveguide 240 shown herein is a parallel-plate waveguide comprising a first rectilinear section 241 in which the wave injected by the sectorial horn (not shown) propagates in the direction opposite to the direction Ox, a rectilinear section 243 in which the wave propagates in the direction Ox after having been reflected on the reflector 250 placed in the transition section, 242, of the guide.

Preferably, the reflector 250 has a cylindrical-parabolic reflective surface whose focal line is vertical, so that the wave injected into the first portion of the guide, with a cylindrical wavefront, is reflected in the form of a planar wave propagating in the second rectilinear section of the waveguide. According to a variant, the primary source is an array of antennas, for example horn antennas supplied in parallel, which radiates a quasi-planar wave into the first portion of the guide. In this case, the reflective surface of the U-like transition is preferably planar.

The reflected planar wave propagates in the first direction and is phase-shifted by passing through a first phase-shifting surface 210. This first phase-shifting surface comprises a first plurality, M, of elementary phase-shifting cells, 211, arranged periodically according to the second direction (y) with a pitch smaller than or equal to the half-wavelength, λ₀/2, where λ₀ is the propagation wavelength in vacuum.

The elementary phase-shifting cells of the first phase-shifting surface apply a phase-shifting law allowing orienting the direction of the beam in the plane (yz).

Afterwards, the planar wave thus phase-shifted propagates according to the direction (Ox) in the second rectilinear section, 243, of the waveguide 240. It is distributed, via an array of stubs, to a second phase-shifting surface 220. The second phase-shifting surface comprises a second plurality, N, of elementary phase-shifting bands, each elementary phase-shifting band being associated with a continuous transverse stub 230 and arranged directly on the latter. The stubs at least partially project out of the upper plane of the PPW guide, their open ends being turned in the direction Oz. The continuous transverse stubs extend in the second direction (Oy), also so-called transverse direction. According to one variant, the stubs could have a zero height (the height being the height of the portion of the stub that protrudes with respect to the neighbouring surface; in this variant, the radiating elements could therefore be assimilated to radiating slots (the term “stub” actually comprising the particular case of a radiating slot).

In any case, the stubs are arranged periodically according to the first direction with, preferably, a pitch substantially equal to the wavelength guided in the waveguide, i.e. λ_{g}.

Where appropriate, each elementary band may consist of a third plurality P of second elementary phase-shifting cells 231, all of the second elementary phase-shifting cells of the same elementary band then applying the same phase-shift to the wave emitted by the stub associated with said band.

Advantageously, the third plurality will be selected equal to the second plurality, in other words P=M.

The elementary phase-shifting bands of the second phase-shifting surface apply a phase-shifting law allowing steering the beam in the plane (xz).

If the elevation and the azimuth corresponding to the desired orientation of the beam are respectively denoted θ₀ and φ₀, one could demonstrate that the application of the phase-shifts

$${ψ}_{m}^{y} ,$$

m=1, . . . , M by the elementary cells of the first phase-shifting surface and of the phase-shifts

$${ψ}_{n}^{x} ,$$

n=1, . . . , N by the elementary bands of the second phase-shifting surface, allows steering the beam in the desired direction (θ₀, φ₀). The values of the phase-shifts

$${ψ}_{n}^{x} ,$$

n=1, . . . , N and

$${ψ}_{m}^{y} ,$$

m=1, . . . , M are defined by:

$${ψ}_{n}^{x} = - n {k}_{0} {d}_{x} sin {θ}_{0} cos {φ}_{0} - ( n - 1 ) {k}_{gx} {d}_{x} \qquad [ Math . 1 ]$$

$${ψ}_{m}^{y} = - m {k}_{0} {d}_{y} sin {θ}_{0} sin {φ}_{0}$$

where

$${k}_{0} = \frac{2 π}{{λ}_{0}}$$

is the wavenumber in vacuum of the wave emitted by the microwave source, k_{gx} is the propagation constant according to the x-axis of the fundamental mode guided by the waveguide, dₓ is the pitch between the elementary phase-shifting bands of the second surface and d_{y} is the pitch between the elementary phase-shifting cells of the first surface. As indicated hereinabove, we will advantageously select d_{y}=λ₀/2 and dₓ=λ_{g}.

According to a first variant, each (first or second) elementary cell, or elementary phase-shifting band, may be made from a series of metal layers alternating with dielectric layers. One or more metal layer(s) include(s) one or more electronic switch(es), for example PIN diodes, allowing varying the frequency response, in particular the phase of the transmission and/or of the reflection coefficient of the elementary cell among a set of discrete values.

Alternatively, according to a second variant, each (first or second) elementary cell, or each elementary phase-shifting band, may be made by means of a varactor-type variable capacitance. This second variant has the advantage of being able to perform a continuous variation of the phase-shift, while the first variant allows only switching between discrete values.

A major advantage of the present invention is to require only a small number of phase-shifting control lines and therefore to simplify the control electronics.

Indeed, 2D electronic scanning antennas of the transmitting array type (transmitarray) require at least as many control lines as cells, namely N×M for a matrix of M rows and N columns. On the contrary, in the present case, assuming that an elementary phase-shifting cell/band could be controlled by means of one single control line, the number of control lines required for the same orientation accuracy now amounts to just N+M.

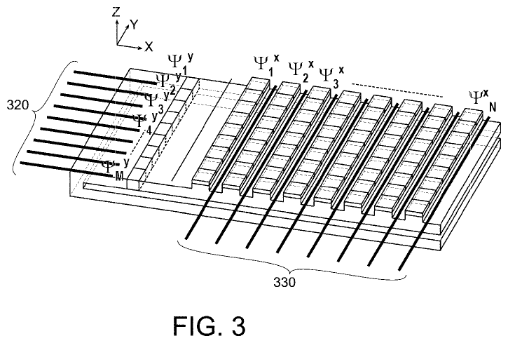

FIG. 3 schematically shows the control lines of the different elementary cells/bands of the first surface and of the second phase-shifting surface.

In this embodiment, each elementary cell of the first surface and/or each elementary band of the second surface is controlled using one single control line. For example, the elementary cells/bands are made from varactors and each control line controls the capacitance of the associated varactor in an analog manner.

When the phase-shifts can take on only a plurality K of discrete values, like in the case of a PIN diode cell, the number of control lines per elementary cell/band could be equal to log₂K. The elementary cells/bands could apply an attenuation in addition to a phase-shifting, so as to be able to apodise the beam and reduce the secondary lobes. In the case where these attenuation coefficients could take on L discrete values, the number of control lines per elementary cell/band then changes to log₂K+log₂L, which leads to a total number of control lines equal to (log₂K+log₂L) (N+M). According to one variant, the attenuation coefficients may be selected so as to be fixed (fixed apodisation) and in this case the number of control lines now amounts to just (N+M) log₂L.

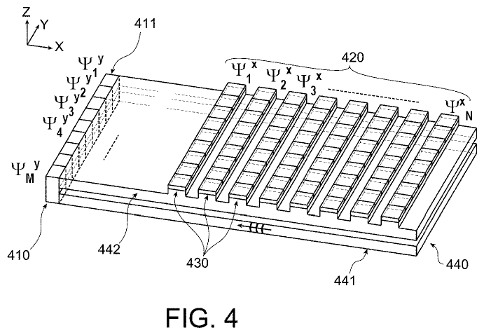

FIG. 4 schematically shows a two-dimensional electron scanning antenna according to the invention.

This embodiment differs from the first one in that the first phase-shifting surface, 410, no longer operates in transmission but in reflection. This configuration allows separating the RF elements of each cell of the surface and the structures necessary for the polarisation of the reconfigurable electronic devices by a ground plane. Indeed, these structures may be arranged outside the guide, which facilitates the interconnection of the reflective surface (the first phase-shifting surface) with its control circuits. The elements bearing the reference signs 420-442 are functionally similar to the elements 220-242. The reference 441 refers to the lower PPW waveguide 441 and the reference 442 the upper PPW waveguide.

In this configuration, the first phase-shifting surface operates as an electronically reconfigurable reflector, and may be made either on a concave or convex surface, or on a planar surface parallel to the plane zy. Consequently, in this embodiment, it is no longer necessary to provide for a parabolic shaped first phase-shifting surface.

Advantageously, the reconfigurable first phase-shifting surface (or reflective surface) may be placed at a distance dᵣ≈3λ_{g/}4+lλ_{g}/2, of the upper surface of the lower PPW waveguide 441 and of the lower surface of the upper PPW waveguide 442, where l is a natural integer (zero or not), and λ_{g} is the wavelength in the two guides at the working frequency.

The wave originating from the microwave source, after having been guided by the first rectilinear section of the guide, is reflected by the first phase-shifting surface 410 before propagating in the second rectilinear section of the guide. The first reflective phase-shifting surface herein applies, on the one hand, where necessary, for example when the surface is planar, a first phase-shifting law aiming to convert the cylindrical wave into a planar wave and, on the other hand, a second phase-shifting law according to the y direction, aiming to steer the beam in the plane (yz). In practice, this optimum phase-shifting law is approximated and established by opportunely selecting the electrical polarisation state of the reconfigurable electronic devices in each cell (for example, PIN diodes) and therefore the phase of the reflection coefficient of each cell between a discrete number K₁ of possible values. To ensure an efficient operation of the reflector, the K₁ values are preferably uniformly spaced over the entire phase range [0-2π) in the working frequency band. In this case, we talk about a cell with log₂K₁ bits, which means that the phase-shift values in reflection carry out a quantisation at log₂K₁ bits of the range [0-2π). For example, a reconfigurable cell capable of introducing the two (four) phase values in reflection 0 and π (or respectively 0, π/2, π, 3π/2), is so-called 1-bit cell (or respectively a 2-bit cell).

Like before, the first elementary cells 411 may further perform an apodisation of the beam (herein orthogonally to the axis (Ox) by applying appropriate attenuation values (for example approximating a cardinal sine).

The 1-bit and 2-bit reconfigurable reflective cells, using PIN diodes, may be made according to known embodiments, such as those suggested for example by the documents:
S. R . . . . Gharbieh, D'Errico, A. Clemente, “Reconfigurable intelligent surface design using PIN diodes via rotation technique-Proof of concept”, in Proc. Eur. Conf. Antennas Propag., EuCAP 2023, Florence, Italy.
F. Liu et al., “A 2-Bit Reconfigurable Reflectarray Unit Design Using Only 2 PIN Diodes”, IEEE MTT-S Int. Microwave Workshop Series on Advanced Materials and Processes for RF and THz Appl., Guangzhou, China, 2022.
H. Luyen, J. Booske, N. Behdad, “2-Bit Phase Quantisation Using Mixed Polarisation-Rotation/Non-Polarisation-Rotation Reflection Modes for Beam-Steerable Reflect arrays”, IEEE Trans. Antennas Propag., vol. 68, no. 12, December 2020.

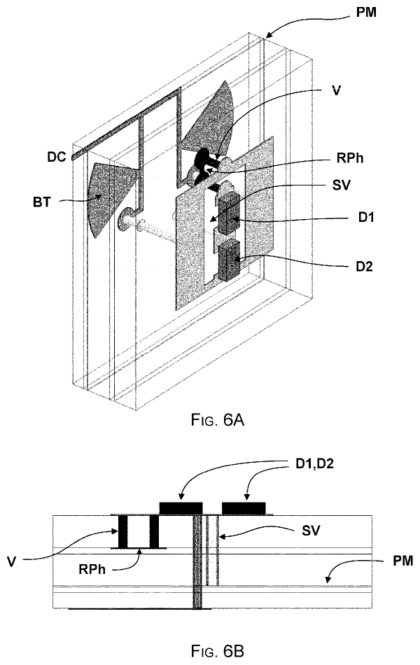

For example, an embodiment for making a 1-bit reflective cell (2 phase-shift values in reflection, with a difference of n) is illustrated by FIG. 6. In this embodiment, the reflective cell has a structure similar to that disclosed in the aforementioned document by S. Gharbieh et al.

In this embodiment, the reflective cell comprises a patch-type antenna with a middle aperture on which two PIN diodes, D1 and D2, are assembled. The two diodes are in an antiparallel configuration: the cathode of D1 and the anode of D2 are DC powered at the same potential, since they are physically connected to a metal pellet at the middle of the aperture. This pellet is connected through a via SV (“shorting via” in English) to a ground plane PM, located under the antenna. The diode D1 can activate and deactivate a 90° phase-delay line RPh, connected by vias V to the patch antenna and made using an intermediate metal layer between the patch antenna and the ground plane. The DC polarisation signal of the diodes is applied to a layer under the ground plane. A structure BT (“bias tee” in English) for decoupling the DC signal and the RF signals is also made. The DC signal is connected to the patch by through vias. In this configuration (contrary to what is described in the aforementioned document by S. Gharbieh et al.), the control lines and the patch antenna are made on opposite sides with respect to the ground plane and therefore do not substantially influence each other: the control lines do not substantially disturb the RF behaviour of the patch antenna and of the cell. Furthermore, the position of the control lines under the ground plane facilitates interconnection thereof with the electronic boards which generate and control the control signals.

In the two operating states, only one of the diodes is directly polarised (ON), while the other one is inversely polarised (OFF). When the diode D1 is OFF and the diode D2 is ON, the delay line is deactivated. The reflected wave is phase-shifted by a value 2×Δφ relative to the incident wave, where Δφ is the phase-shift acquired by the wave as it propagates between the patch and the ground plane. In the other operating state, the diode D1 is ON and the diode D2 is OFF, and the 90° phase-delay line is active. In this case, the phase-shift between the reflected wave and the incident wave is 2×Δφ+2×90°=2×Δφ+180°. Hence, the phase difference between the phases of the reflection coefficients in the two operating states is 180°.

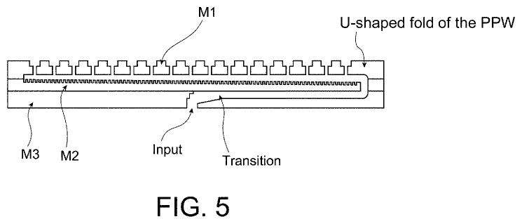

Finally, the PPW waveguide 240 or 440 may be made according to different variants. According to a first variant, the space between its parallel plates is simply filled with air. According to a second variant, this space is occupied by a dielectric. According to a third variant, schematically shown in FIG. 5, a slow-wave structure (slow-wave structure) is provided by crenelating the lower plate of the second rectilinear section of the waveguide, and by inclining it with respect to which upper metal plate in which the stubs are formed. It should herein be noted that the spacing between the upper plate M1 and the lower plate M2 is reduced in the direction of propagation (Ox) and that the lower plate M2 has corrugations over its upper face, in the direction (Oz). The presence of a dielectric and a fortiori of a slow-wave structure in the waveguide allows lowering the phase speed and reducing the guided wavelength. As a result, the pitch of the array of continuous stubs may be selected to be smaller, which allows avoiding the apparition of secondary lobes and extending the angular scanning range.

1. A two-dimensional beam scanning antenna comprising a waveguide configured to be powered by a microwave source and to supply a quasi-planar wave propagating in a first direction, a linear array of transverse stubs, extended according to a second direction perpendicular to the first one, the stubs being arranged periodically according to the first direction with a pitch substantially equal to a wavelength guided in the waveguide, comprising:
a first electronically reconfigurable phase-shifting surface comprising a first plurality of elementary phase-shifting cells arranged periodically according to the second direction with a pitch smaller than or equal to a free space half-wavelength of the microwave source;
a second electronically reconfigurable phase-shifting surface comprising a second plurality of elementary phase-shifting bands, each elementary phase-shifting band being extended according to the second direction and being associated with a transverse stub of the array, the elementary phase-shifting band being arranged directly on an output of the transverse stub to which it is associated;
a first set of control lines for controlling respective phase-shifts of the elementary phase-shifting cells so as to control an orientation of the beam in a plane orthogonal to the first direction; and
a second set of control lines for controlling the respective phase-shifts of the elementary phase-shifting bands so as to control an orientation of the beam in a plane orthogonal to the second direction;
wherein the first phase-shifting surface is a reflective phase-shifting surface configured to receive a wave supplied by the microwave source propagating in a direction opposite to the first direction and to reflect it in the first direction after the elementary phase-shifting cells have applied thereto first phase-shift values along the second direction.

2. The two-dimensional beam scanning antenna according to claim 1, wherein each elementary cell of the first surface and/or each elementary band of the second surface is controlled using one single control line.

3. The two-dimensional beam scanning antenna according to claim 1, wherein at least one of the reconfigurable surfaces comprises PIN diodes.

4. The two-dimensional beam scanning antenna according to claim 2, wherein the waveguide is a parallel-plate waveguide.

5. The two-dimensional beam scanning antenna according to claim 4, wherein the waveguide comprises a first rectilinear section in which the wave emitted by the microwave source propagates in a direction opposite to the first direction, a second rectilinear section, parallel to the first rectilinear section, wherein the wave propagates in the first direction after having been phase-shifted by the first phase-shifting surface and a U-shaped transition section ensuring 180° folding and connecting the first rectilinear section to the second rectilinear section.

6. The two-dimensional beam scanning antenna according to claim 5, wherein the waveguide is fed by the microwave source through a sectorial horn.

7. The two-dimensional beam scanning antenna according to claim 1, wherein the first phase-shifting surface is arranged on a cylindrical-parabolic structure.

8. The two-dimensional beam scanning antenna according to claim 1, wherein each elementary phase-shifting band consists of a plurality of second elementary cells, the plurality of second elementary cells of a elementary phase-shifting band being arranged periodically according to the second direction with a pitch smaller than or equal to the free space half-wavelength, a same phase-shift value being applied to said plurality of second elementary cells belonging to a same elementary phase-shifting band.

9. The two-dimensional beam scanning antenna according to claim 8, wherein each first elementary cell, respectively each second elementary cell, comprises a plurality of metal layers alternating with dielectric layers as well as a plurality of PIN diodes interconnecting at least some of different ones of the metal layers, controlled by a plurality of control lines of the first and second sets, respectively.

10. The two-dimensional beam scanning antenna according to claim 8, wherein each first elementary cell, respectively each second elementary cell comprises a plurality of varactor diodes, controlled by at least one control line of the first set and second set, respectively.

11. The two-dimensional beam scanning antenna according to claim 1, wherein each elementary cell of the second phase-shifting surface is configured to radiate a field having a fixed circular polarisation.

12. The two-dimensional beam scanning antenna according to claim 1, wherein each elementary cell of the second phase-shifting surface is configured to radiate a circular polarisation field with an electronically reconfigurable direction.

13. The two-dimensional beam scanning antenna according to claim 1, configured to emit two beams, with orthogonal polarisations and independently controllable, wherein each band of the second phase-shifting surface comprises two sets of reconfigurable phase-shifting cells configured to radiate fields having orthogonal polarisations.
